(19) United States
(12) Patent Application Publication
(10) Pub. No.: US 2008/0170963 A1
(43) Pub. Date: Jul. 17, 2008

(54) Wine preservation system

(75) Inventor: Clifford Cantrell, Rogers, KY (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Liber, Limited

(21) Appl. No.: 12/008,210

(22) Filed: Jan. 9, 2008

Related U.S. Application Data
(60) Provisional application No. 60/884,499, filed on Jan. 11, 2007.

(51) Int. Cl. B01J 19/16; B67D 1/08

(52) U.S. Cl. 422/41; 222/152

(57) ABSTRACT

An apparatus and method are provided for dispensing degradable liquids, such as wine, from a pressure-intolerant container such as glass bottle, while insuring that ambient air cannot contact the degradable liquid. A preserving liquid is floated on the surface of the degradable liquid providing an effective gas barrier. A method is defined for dispensing limited quantities of wine while maintaining the protective layer of liquid.

### REFERENCE TO RELATED APPLICATIONS

This application claims priority to U.S. Provisional Patent Application No. 60/884,499, filed Jan. 11, 2007 the entire specification of which is incorporated herein by reference.

### TECHNICAL FIELD

This invention relates generally to methods of preventing oxidation in liquids, and specifically, to preventing oxidation in bottled wine by protecting the wine from contact with oxygen after the bottle has been opened.

### BACKGROUND

It is known that wine begins to oxidize once exposed to ambient air, changing the wine's taste and severely limiting the shelf life of an open bottle of wine. Oxidation causes wine to suffer a loss in quality of color, taste, and composition. Because open wine spoils within a matter of hours or days, many restaurants offer only a few options for purchasing wine by the glass. Spoilage creates waste and lost profits when opened bottles of wine are not consumed during their useful shelf life. This often limits the selection of wines offered by the glass to wines that are either (a) relatively inexpensive or (b) so popular that they are virtually guaranteed to be consumed shortly after opening (e.g., Chardonnay, Merlot, etc.). There is little incentive for restaurants or bars to offer expensive wines, older vintages, or lesser-known varietals by the glass where the likelihood of unfinished bottles and spoilage is great.

There are several known devices and methods aimed at slowing the oxidation of wine in open bottles. One known method involves freezing the remaining wine after the bottle has been opened. This technique prevents oxidation, but substantial time is required to thaw the wine after it has been frozen and therefore, this method is of only limited practical use. Another method involves minimizing contact between the wine and air by decanting the remaining contents of an opened wine bottle into a container that is sized exactly to hold the wine poured into it, then sealing the container. However, this method is labor intensive, and obtaining an exact match of container capacity and the volume of wine being decanted is very difficult. Further, the process must be repeated with a different-sized decanter each time some wine is dispensed.

A commonly-used device is a vacuum pump that evacuates a substantial portion of air from the wine bottle. However, this device is only marginally effective, and only for a few days, because achieving and maintaining a true vacuum in the wine bottle is difficult, if not impossible; thus, some amount of oxygen remains in contact with the wine. Additionally, the process must be repeated each time some wine is dispensed from the bottle. Another device uses a container of compressed inert gas to displace the oxygen in the bottle. This method can be effective if used properly, but must be repeated each time wine is dispensed from the bottle. A very effective system uses a compressed nitrogen system to displace the air in a wine bottle. This system typically holds and preserves several bottles at a time, and allows the wine to be dispensed without exposing the bottled wine to ambient air. However, that system is expensive—typically well beyond the reach of the average wine drinker—and bulky, and takes up valuable space in a restaurant or bar. Additionally, such systems require periodic maintenance and a constant supply of compressed inert gas.

Historically, wine was preserved by floating a film of olive oil on the surface of wine that was stored in wide-mouthed containers called amphorae. The olive oil effectively isolated the wine from oxidation and could be easily scooped off before the wine was consumed. Modern bottles have narrow mouths and therefore it is impractical to scoop a layer of oil from the wine. Additionally, olive oil tends to react with the wine and impart an undesirable flavor to the wine.

A device is needed to effectively and inexpensively preserve wine in opened bottles.

### BRIEF DESCRIPTION OF THE DRAWINGS

For the purpose of illustrating the invention, there are shown in the drawings embodiments that are presently preferred; it being understood, however, that this invention is not limited to the precise arrangements and constructions particularly shown. In the drawings:

FIG. 1 is a perspective view of one embodiment of a wine preservation system according to the present invention showing the bottle in its operational orientation, viewed from below.

FIG. 2 is a perspective view of the embodiment of FIG. 1 viewed from above.

FIG. 3 is an elevation view of one embodiment of the stopper assembly with a vent-tube, dispensing-tube and control valve.

FIG. 4 is a bottom view of the embodiment shown in FIG. 1 and FIG. 2.

FIG. 5 is a cross section view of the embodiment shown in FIG. 4, seen along line 5-5.

FIGS. 6A-C are side views of the operation of another embodiment of the present invention.

FIG. 7 is a perspective view of an alternative embodiment of the preservation system of the present invention.

FIG. 8 is a perspective view of a further alternative embodiment of the preservation system of the present invention.

### DETAILED DESCRIPTION OF THE DRAWINGS

Referring now to the drawings that illustrate several preferred embodiments of the invention, a preservation system is shown for use on a wine bottle or similar container having a neck.

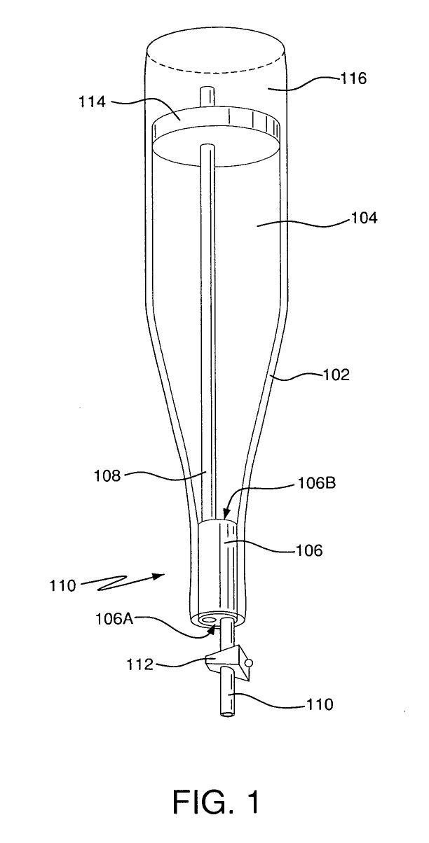

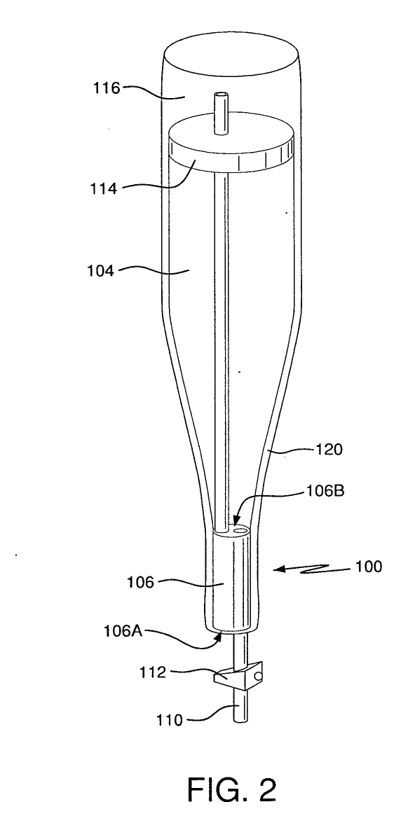

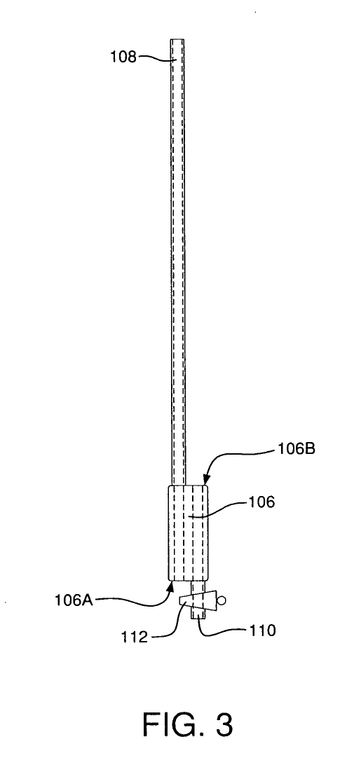

FIGS. 1 and 2 are perspective views of one embodiment of a wine preservation system 100 according to the present invention. When operational, a bottle 102 containing wine 104 is oriented in an inverted position with a stopper 106 inserted into the neck of bottle. As shown in FIG. 3, a vent tube 108 and a dispensing tube 110 create passageways through the stopper. The vent tube preferably begins at or near a first end 106A of the stopper, and preferably runs through the stopper and beyond with sufficient length so that it extends almost to the base of the bottle when the stopper is inserted into the bottle. The vent tube provides an unobstructed passage for air going from outside the bottle to the base of the bottle. While the vent tube preferably extends above the surface of the perishable liquid, the vent tube may include a check valve, which allows air or liquid to flow into the bottle but does not allow the contents of the bottle to flow out. The incorporation of a check valve obviates the need to extend the vent tube beyond the surface of the bottle contents, as will become evident below.

The dispensing tube 110 preferably begins at a second end 106B of the stopper, and extends through the stopper and beyond with sufficient length to allow for the installation of a valve 112 and to provide for ease of dispensing. The dispensing tube may extend beyond the second end 106B of the stopper if desired, for example, to avoid dispensing sediment from an unfiltered wine. The dispensing tube 110, vent tube 108, and the stopper 106 can be constructed as a single entity, or the tubes can be separate parts inserted into the stopper provided a reliable seal is made between the outside of the tubes and the stopper. Additionally, the dispensing tube may be incorporated into a dispensing system that automatically dispenses a pre-determined amount of liquid, such as described in U.S. Pat. Nos. 3,993,218 or 4,027,783. Such systems are used in bars and restaurants to ensure drinks are accurately dispensed.

An embodiment of the present invention provides for the introduction of a layer of hydrophobic non-reactive preserving liquid 114 into the bottle, to overlie the surface of the wine to prevent oxygen from contacting the wine. The preserving liquid may be introduced into the bottle through various methods such as those described below so as to form a complete layer on the surface of the wine as shown in the figures. In order to permit the wine to pass readily out of the bottle, ambient air is channeled into the bottle through the vent tube 108. The vent tube creates an air passage through the stopper, the wine, and the preserving liquid thereby permitting air to flow into the space 116 above the wine as the wine is dispensed. This allows the wine to flow smoothly from the dispensing tube.

The invention is designed to be used with a bottle 102 made of conventional materials, such as glass, plastic, or other rigid material. Preferably, the bottle 102 is the bottle in which the wine was purchased; however, it may be a secondary bottle or vessel into which the wine has been decanted. Stopper 106 seals the bottle and prevents the wine from draining out of the bottle when the bottle is inverted. The stopper is preferably constructed from a semi-elastic material such as rubber, silicone, plastic, or cork, and is designed to be press-fit into the mouth of the bottle to form an airtight seal with the mouth. Alternatively, the stopper may be created from other materials, such as metal or glass, and may use other means of attachment to the bottle, such as such as screw type closures, o-ring seals, expanding ring closures, or external sealing caps. As discussed above, the vent tube and dispensing tube can be integrated into the stopper, or they can be inserted into the stopper as separate pieces, provided a reliable seal is made between the outside of the tubes and the stopper.

The valve 112 regulates the flow of wine through the dispensing tube, and creates an effective air barrier when closed. The specific type of valve used is not crucial to this invention, and can take on many forms including ball valve, gate valve, pinch valve, or any other valve type of suitable function. The actuating portion of the valve can also take on many well-known forms such as a lever, button, pinch, or any other suitable valve actuating mechanism.

As shown in FIGS. 1 and 2, the layer of preserving liquid 114 floats on the surface of the wine. The layer is preferably between about 0.5 and 3 centimeters thick, enough to prevent oxygen from contacting the wine. Depending on the liquid to be preserved, the preserving liquid can be made of any non-reactive liquid that has a density lower than that of the perishable liquid, and that will not mix with the perishable liquid. Suitable materials for preserving wine preferably include unsaturated lipids in combination with an antioxidant. Examples of suitable lipids are castor oil and peanut oil, although any highly-refined lipid may be used. Examples of suitable antioxidants include butylated hydroxyanisole (BHA), butylated hydroxytoluene (BHT), and tertiary butyl hydroquinone (tBHQ). The use of an antioxidant in combination with the lipid is preferred because the use of unsaturated lipids alone may lead to an auto-oxidation process, failing to insulate the wine from contact with oxygen, thus leading to its oxidation. Alternatively, organic or inorganic oils may be used. Suitable examples include white mineral oil and silicone oil (such as polydimethylsiloxane).

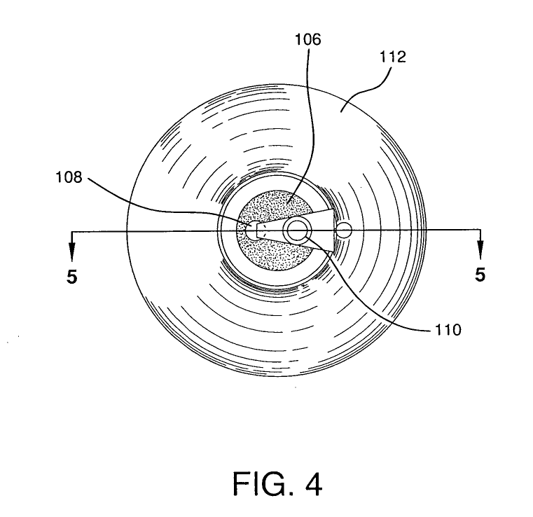

FIG. 4 is a bottom view of an embodiment of this invention, showing the orientation of the components. The dispensing tube 110 and vent tube 108 are preferably off-center in the stopper, although any arrangement that provides enough space to accommodate both tubes may be used. It is contemplated that the tubes can be formed as two conjoined tubes or as co-axial tubes, within the scope of the invention.

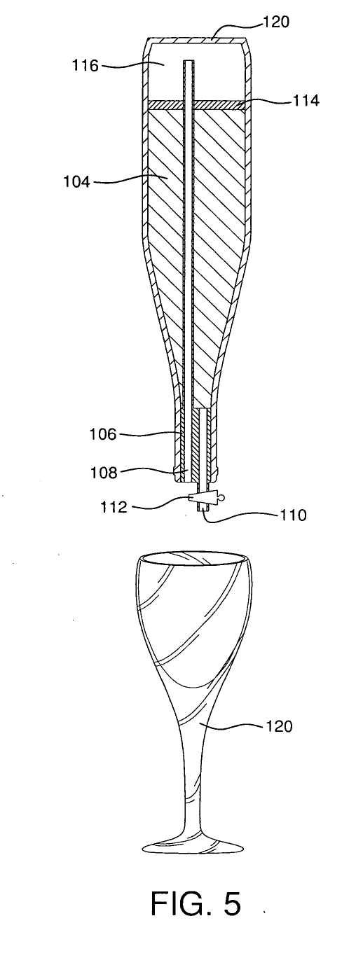

FIG. 5 is a cross-sectional view of the embodiment shown in FIG. 4, seen along line 5-5, and illustrates a method of dispensing the wine. As valve 108 is opened, the wine flows through dispensing tube 110 into glass 120. As the wine level drops, ambient air is drawn into the bottle through the vent tube 108. Because the top of the vent tube is above the level of the wine and the preserving liquid 114, the wine does not escape through the vent tube, and the air entering the bottle does not contact the wine. When a desired amount of wine has been dispensed, the valve is closed.

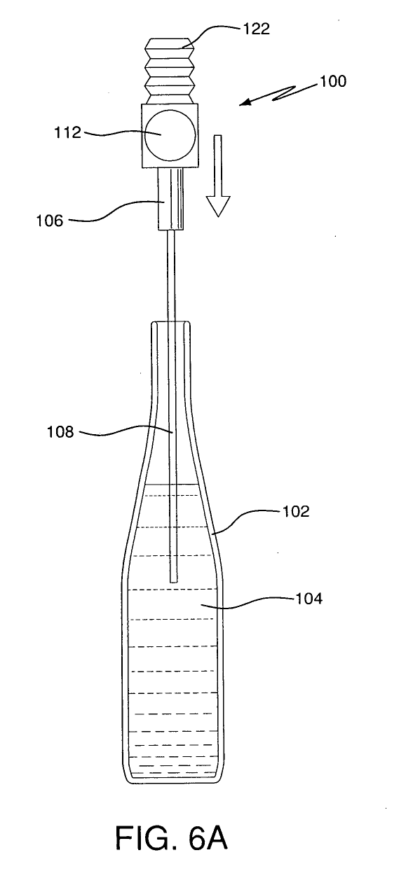

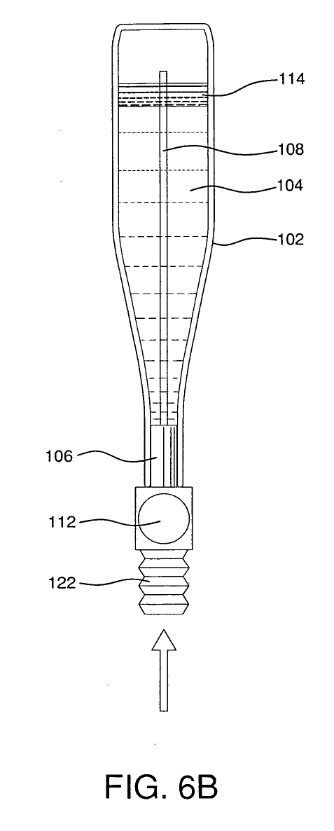

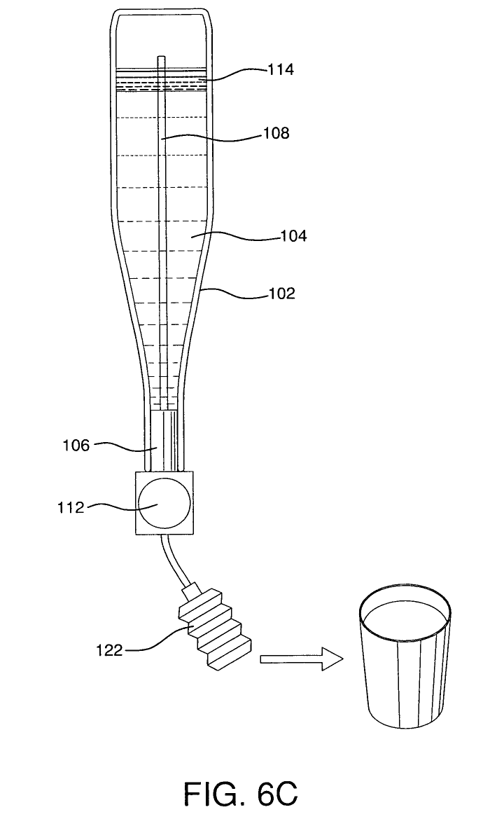

FIGS. 6A-6C show the operation of another embodiment of the present invention. The stopper 106 is inserted into the neck of a wine bottle 102. Removably attached to stopper 106 and vent tube 108 is a liquid storage container 122, which contains the preserving liquid. The container may include means for retaining the preserving liquid in the container, including an internal diaphragm (not shown) or a removable external cap (not shown). As shown in FIG. 6B, once the stopper is inserted into the bottle, the bottle is inverted, or placed at an angle at which the mouth of the bottle is below its base, and at which the end of the vent tube 108 is exposed inside the bottle. The container 122 is then compressed, forcing the preserving liquid through the vent tube and into the bottle, where it floats on top of the wine. As shown in FIG. 6C, the container may then be discarded, and the bottle is ready to dispense wine as already described. Alternatively, the stopper may include a sealable third tube (not shown) through which the preserving liquid may be introduced into the bottle. Also, while a single-use container is shown, a multi-use container, containing sufficient preserving liquid to fill a number of bottles, may also be used. Dispensing of the preserving liquid from the container can be performed using a variety of mechanisms, including by compressing or squeezing the container. Alternatively, the container may be permanently incorporated into the stopper.

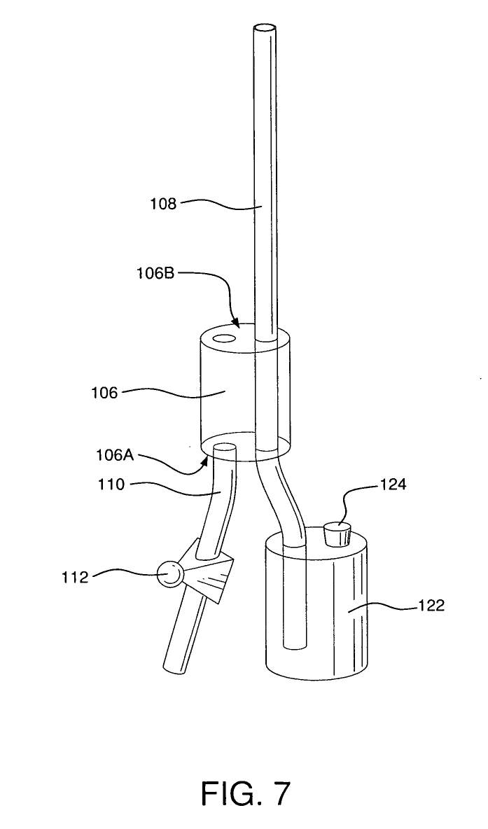

FIG. 7 shows a further embodiment of the invention. In this embodiment, the container 122 is attached to the vent tube 108, which in this embodiment extends past stopper 106. The stopper 106 is inserted into the bottle as previously described. The exposed end of the vent tube is inserted into the preserving liquid container 122, and the bottle is inverted. When wine is dispensed from the bottle, a negative pressure is created inside the bottle. A container plug 124 is removably attached to the container. When the container plug is removed, the interior of the container 122 is vented to the atmosphere. Thus, the negative pressure within the bottle 102 will draw the preserving liquid from the container through the vent tube and into the bottle. Once a sufficient amount of the preserving liquid is drawn into the bottle the container may be removed and the vent tube will function as in the first embodiment described. Alternatively, the container may be permanently attached to the vent tube. In either instance, the vent tube will function as in the first embodiment described. In this embodiment, the container plug prevents the liquid from leaking into the bottle before the bottle is inverted; its removal also allows the preserving liquid to be drawn into the bottle by the negative pressure created when wine is dispensed.

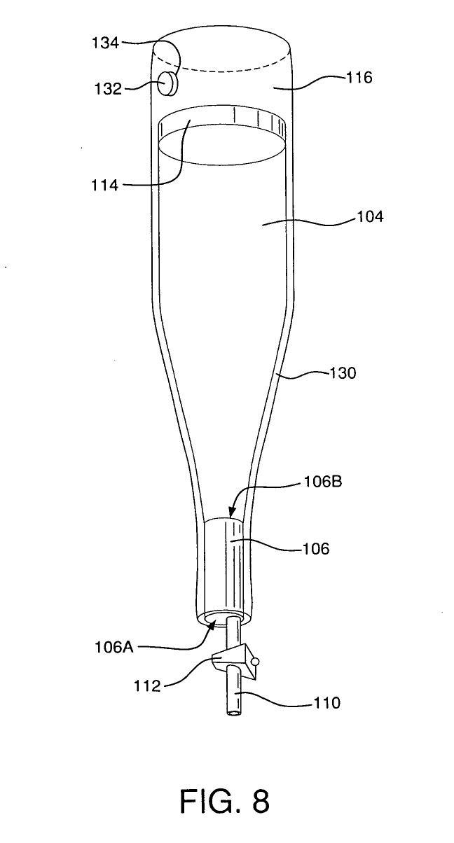

FIG. 8 shows a still further embodiment using a vented vessel 130 and a stopper including a dispensing tube but no vent tube. In this embodiment, the wine is decanted into the vessel and the stopper is affixed to an opening in the vessel. When the vessel is inverted to place the stopper at the vessel's lowest point, a plug 132 is removed from a vent hole 134 located at a point on the vessel above the level of the wine. The preserving liquid 114 may then be added through the vent hole, forming a layer on top of the wine. As the wine is dispensed, ambient air 116 enters the vessel 130 through the vent hole 134, allowing the wine to flow smoothly from the dispensing tube. However, the air is prevented from contacting the wine by the layer of preserving liquid 114.

Other methods of placing the preserving liquid in the bottle will be appreciated by those skilled in the art. For example, the preserving liquid may simply be poured into an open wine bottle before the stopper is inserted. After the stopper is inserted, the wine bottle may be inverted and the liquid, being less dense than the wine, will rise to the top. This method may be perceived as less desirable because the preserving liquid tends to adhere to surfaces within the bottle and dispensing tube; when wine is dispensed, it carries with it some amount of preserving liquid and takes on an undesirable oily appearance.

### Testing

The pH values of a bottle of wine preserved using the present invention and an identical, unpreserved control bottle were tracked for a 25-day period. The test used 3 centimeters of mineral oil as a preserving liquid. After four days, the pH level of the unpreserved sample had dropped from an initial 3.15 to 2.9, indicating that the wine was thoroughly spoiled. By contrast, the pH level of the sample preserved by the present invention remained constant for almost 25 days. Additionally, 30-day tests were run using several combinations of unsaturated lipids and antioxidants, and subjects were unable to identify a freshly opened control bottle.

It will be apparent to those skilled in the art that various modifications and variations can be made in the configuration of the present invention without departing from the spirit or scope of the invention. For example, this system be used with liquids other than wine that suffer ill effects when exposed to ambient air, such as fruit juices or perfumes. It is intended that the present invention cover such modifications and variations provided they come within the scope of the appended claims or their equivalents.

I claim:

1. A method of preventing oxidation of a liquid contained in a vessel having an opening through which the liquid may be dispensed and through which air may enter the vessel when dispensing the liquid, the method comprising:
sealing the vessel opening to allow liquid to be selectably dispensed from the vessel through a controllable opening and to allow air to selectably enter the vessel;
introducing a preserving liquid into the vessel through the vessel opening, the preserving liquid having a density lower than the density of the perishable liquid; and
orienting the vessel such that the controllable opening is located adjacent the lowest point of the vessel.

2. The method of claim 1, wherein the step of sealing the vessel opening to allow liquid to be selectably dispensed from the vessel through a controllable opening and to allow air to selectably enter the vessel includes inserting into the opening a stopper having a dispensing channel extending therethrough to allow the liquid to exit the vessel, the dispensing channel including a means for selectably preventing the flow of perishable liquid therethrough, and having a vent channel extending through the stopper, the vent channel being adapted to allow air to flow into the vessel without allowing perishable liquid to exit the vessel through the vent channel.

3. The method of claim 1, wherein the preserving liquid is introduced into the vessel after the vessel sealing step.

4. The method of claim 2, wherein the preserving liquid is introduced into the vessel through the venting means after the vessel orienting step.

5. The method of claim 1, wherein the preserving liquid is introduced in an amount sufficient to form a layer with a thickness of between about 0.5 and 3 centimeters.

6. The method of claim 1, wherein the preserving liquid comprises an unsaturated lipid.

7. The method of claim 6, wherein the preserving liquid further comprises an antioxidant.

8. The method of claim 1, wherein the preserving liquid comprises an organic or inorganic oil.

9. The method of claim 7, wherein the antioxidant comprises BHA.

10. The method of claim 8, wherein the preserving liquid further comprises an antioxidant.

11. An apparatus for preserving a perishable liquid in a vessel, the apparatus comprising:
a stopper adapted to sealingly engage an opening in a vessel for containing a perishable liquid;
a dispensing channel extending through the stopper so as to allow the perishable liquid to exit the vessel, the dispensing channel including means for selectably preventing the flow of perishable liquid through the dispensing channel; and
venting means adapted so as to allow liquid or gas to enter the vessel while not allowing the perishable liquid to exit the vessel.

12. The apparatus of claim 11, wherein the venting means includes a tube extending through the stopper and terminating at a point inside the vessel when the stopper is attached to the vessel.

13. The apparatus of claim 11, further comprising a storage container for a preserving liquid, the container including a dispensing portion adapted to be connected to the venting means for introducing the preserving liquid into the vessel through the venting means.

14. The apparatus of claim 13, further comprising a liquid introduction tube, wherein the storage container dispensing portion is adapted to be connected to the liquid introduction tube for introducing the preserving liquid into the vessel through the liquid introduction tube.

15. The apparatus of claim 11, the apparatus further comprising a vessel, and wherein the venting means is an opening in the vessel, the opening located at a point above the level of the perishable liquid when the vessel is oriented so as to place the stopper at the vessel's lowest point.

16. A method of preventing oxidation of a liquid contained in a vessel having an opening, the method comprising:
providing a vessel containing perishable liquid;
sealing the vessel opening to allow liquid to be selectably dispensed from the vessel through a controllable opening and to allow air to selectably enter the vessel;
inverting the vessel such that the sealed opening is adjacent the lowest point of the vessel; and
dispensing perishable liquid from the vessel so as to create a negative pressure in the vessel, the negative pressure drawing a preserving liquid from a storage container and into the vessel, the preserving liquid having a density lower than the density of the perishable liquid.

17. The method of claim 16, wherein the preserving liquid comprises an unsaturated lipid.

18. The method of claim 17, wherein the preserving liquid further comprises an antioxidant.

19. The method of claim 16, wherein the preserving liquid comprises an organic or inorganic oil.

20. The method of claim 18, wherein the antioxidant comprises BHA.

21. The method of claim 19, wherein the preserving liquid further comprises an antioxidant.

22. The method of claim 16, wherein the preserving liquid is introduced in an amount sufficient to form a layer with a thickness of between about 0.5 and 3 centimeters.

23. An apparatus for preserving a perishable liquid such as wine in a wine bottle having an opening and a bottom, comprising:
a stopper adapted to sealingly engage the opening, the stopper having a first end and a second end;
a venting channel extending through the stopper, a first end of the venting channel adapted to extend into the bottle beyond the second end of the stopper and terminating at a point near the bottom of the bottle when the stopper is attached to the bottle, and an opposite end of the venting channel terminating at or beyond the first end of the stopper so as to permit air to communicate from one side of the stopper to the other through the venting channel, the opposite end of the venting channel being removably connectable to a second container so as to allow a preserving liquid to flow from the second container into the bottle through the venting channel; and
a dispensing channel extending through the stopper, the dispensing channel including means to selectably permit the flow of perishable liquid therethrough;
wherein the flow of perishable liquid through the dispensing channel creates a negative pressure in the vessel, which draws preserving liquid from the second container through the venting channel and into the vessel.

24. A method of preventing oxidation of a liquid contained in a vessel having a bottom, a first sealed opening proximate the bottom, and a second opening, the method comprising:
sealing the second opening to allow liquid to be selectably dispensed from the vessel through the sealed second opening;
unsealing the first opening to allow air to enter the vessel;
introducing a preserving liquid into the vessel through the first opening, the preserving liquid having a density lower than the density of the perishable liquid; and
orienting the vessel such that the second opening is located adjacent the lowest point of the vessel.
